(19) United States
(12) Patent Application Publication
(10) Pub. No.: US 2015/0263410 A1
(43) Pub. Date: Sep. 17, 2015

(54) ANTENNA ASSEMBLY WITH MULTIPLE COMPONENT AND ASSEMBLY METHOD OF THE SAME

(71) Applicant: FOXCONN INTERCONNECT TECHNOLOGY LIMITED, Grand Cayman (KY)

(72) Inventors: TZU-YAO HWANG, New Taipei (TW); LUNG-SHENG TAI, New Taipei (TW)

(21) Appl. No.: 14/645,790

(22) Filed: Mar. 12, 2015

(30) Foreign Application Priority Data
Mar. 12, 2014 (TW) 103108593

(51) Int. Cl. H01Q 1/22; H01Q 1/48

(52) U.S. Cl. CPC H01Q 1/22; H01Q 1/48

(57) ABSTRACT

An antenna assembly is adapted for mounting on an electronic device and includes an antenna body including a horizontal grounding plate, a radio plate and a connecting plate connecting with the grounding plate and the radio plate; a feed cable connecting with the antenna body; an insulating holder defining a bottom wall and sidewalls extending from the bottom wall. The grounding plate of the antenna body is held on an upper face of the bottom wall, the radio plate and a connecting plate are surrounded between the sidewalls. The grounding plate defines a retaining leg retained in the insulating holder and extending to a lower face of the bottom wall opposite to the upper face, the lower face of the bottom wall is confronting with the electronic device.

### BACKGROUND OF THE INVENTION

1. Field of the Invention

The present invention relates generally to an antenna assembly, and more particularly to an antenna assembly used in electric device.

2. Description of the Prior Art

Nowadays, antennas are used more and more in electronic device to establish a wireless signal transmission. Generally, the antennas are assembled in the device by bolting or paste on the devices. Thinner and smaller electronic devices are limited to provide antenna-receiving space. The smaller antenna is difficult to assembly and retain in the space.

Hence, in this art, an improved antenna assembly to overcome the above-mentioned disadvantages of the prior art should be provided.

### BRIEF SUMMARY OF THE INVENTION

A primary object, therefore, of the present invention is to provide an antenna assembly with an improved supporting device.

In order to implement the above object, an antenna assembly is adapted for mounting on an electronic device. The antenna assembly comprises an antenna body comprising a horizontal grounding plate, a radio plate and a connecting plate connecting with the grounding plate and the radio plate; a feed cable connecting with the antenna body; an insulating holder defining a bottom wall and sidewalls extending from the bottom wall, the grounding plate of the antenna body being hold on an upper face of the bottom wall, the radio plate and a connecting plate being surrounded between the sidewalls. The grounding plate defines a retaining leg retained in the insulating holder and extending to a lower face of the bottom wall opposite to the upper face, the lower face of the bottom wall is confronting with the electronic device.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a top perspective view of an antenna assembly in according with the present invention;

FIG. 2 is a bottom perspective view of the antenna assembly in FIG. 1;

FIG. 3 is an exploded perspective view of the antenna assembly of FIG. 1;

FIG. 4 is an exploded perspective view of the antenna assembly of FIG. 2;

FIG. 5 is a perspective view of the antenna body; and

FIG. 6 is a perspective view of the antenna unit.

### DETAILED DESCRIPTION OF THE INVENTION

Reference will now be made in detail to a preferred embodiment of the present invention.

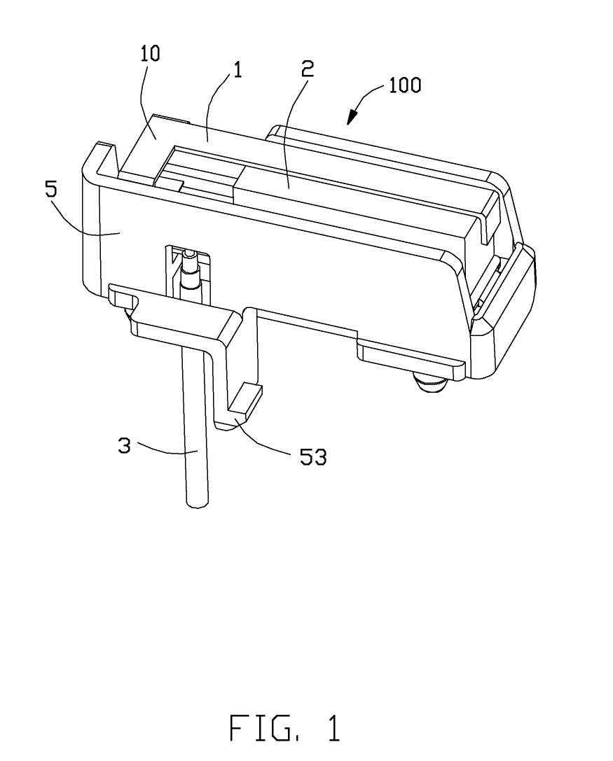

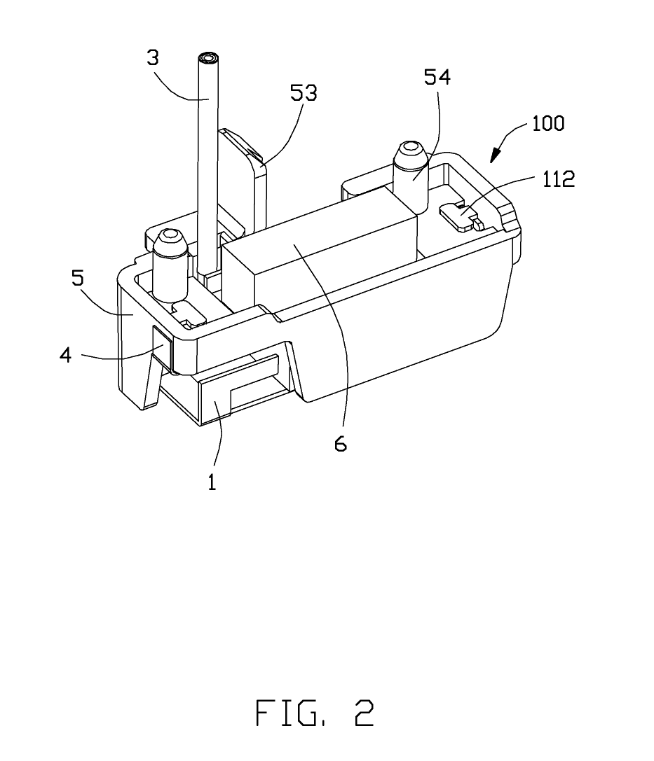

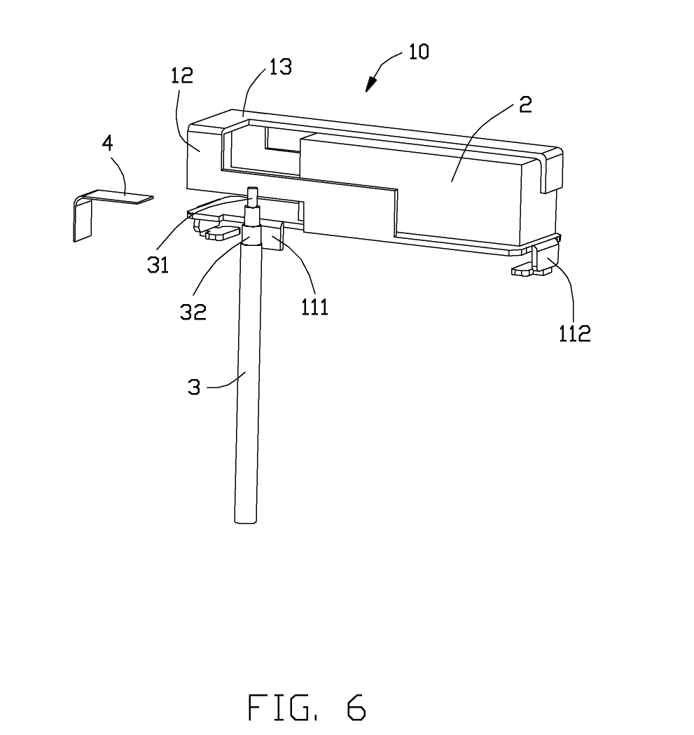

Reference to FIGS. 1 to 2, an antenna assembly 100 in according with a preferred embodiment of the present invention is shown. The antenna assembly comprises 100 includes an antenna unit 10, an insulating holder 5 holding the antenna unit 10 and a conductive gasket 6 connecting with the antenna unit 10. The antenna unit 10 as best shown in FIG. 6 includes an antenna body 1, an insulating spongy 2, a feeder coaxial cable 3 connecting with the antenna body 1 and a metal foil 4 attached to the antenna body 1.

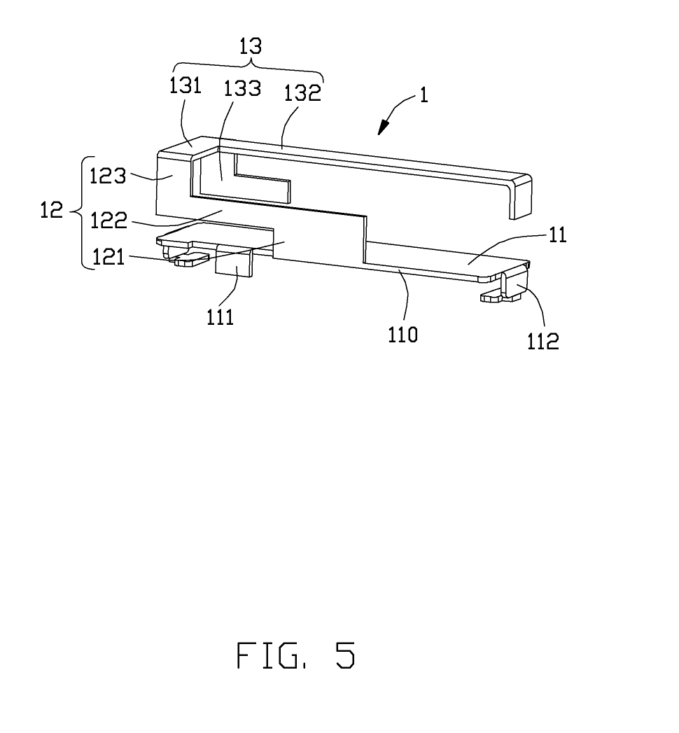

Referring to FIGS. 5 and 6, the antenna body 1 includes a longitudinal and horizontal grounding plate 11, a connecting plate 12 perpendicular and upwards bending from a longitudinal side 110 of the grounding plate 11 and a radio plate 13 perpendicular bending from a top side of the connecting plate 12. The grounding plate 11 defines a tab 111 bending downwards from the longitudinal side 110 at a point near to the connecting plate 12 and two retaining legs 112 bending downwards from opposite longitudinal ends thereof. The retaining legs 122 are of an inverted H shape before bending to retain with the insulating holder 5. The connecting plate 12 is of an inverted Z shape, which includes a first section 121, a third section 123 and a second section 122 jointing with the first section and third section. The second section 122 extends along the longitudinal direction, the first section 121 joints with the grounding plate 11 and the third section 123 joints with the radio plate 13. The radio plate 13 includes a common section 131 jointing with the third section 123, and a lower frequency radio section 132 horizontally extending from the common section 131 and a higher frequency radio section 133 perpendicular and downwards bending from the common section 131. The higher frequency radio section 133 is parallel to the connecting plate 12, the common section 131 and the lower frequency radio 132 is parallel to the grounding plate 11, thereby defining a rectangular space among the grounding plate 11, the connecting plate 12 and the radio plate 13. The insulating spongy 2 is disposed in the rectangular space to support and preventing the antenna body 1 from deforming. The insulating spongy 2 is sandwiched between the radio plate, the grounding plate and the connecting plate. The feeder cable 3 includes a core conductive wire 31 connecting with the second section 122 of the connecting plate 12 and a shielding layer 32 connecting with the tab 111 of the grounding plate 11.

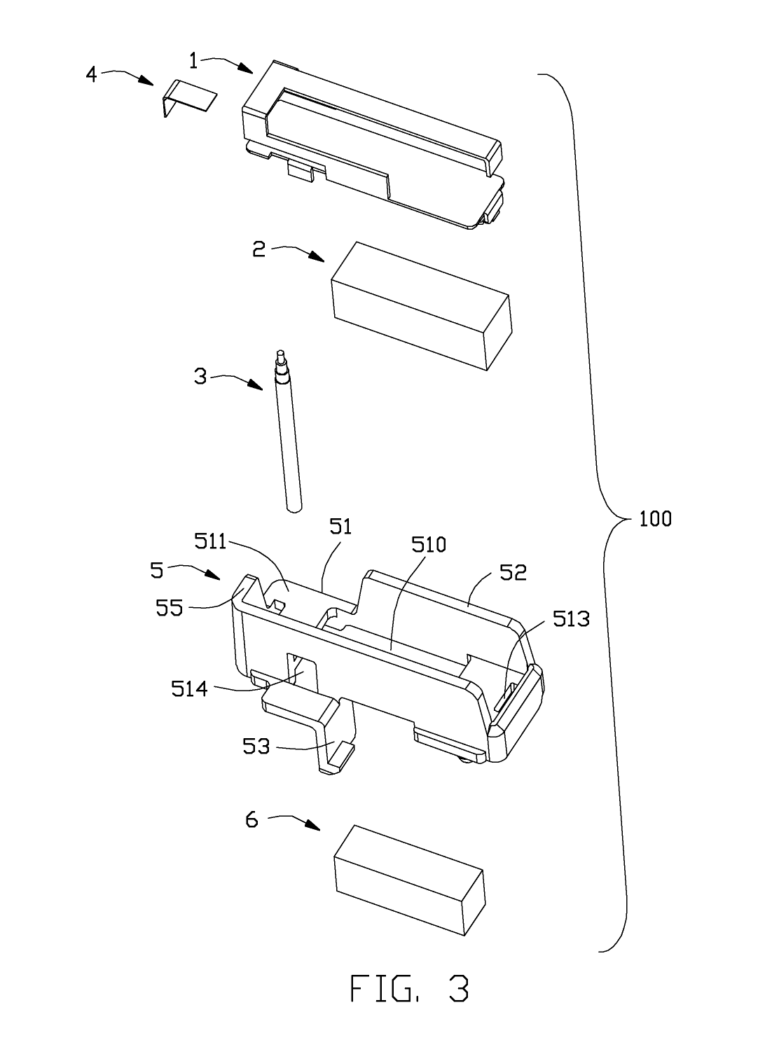

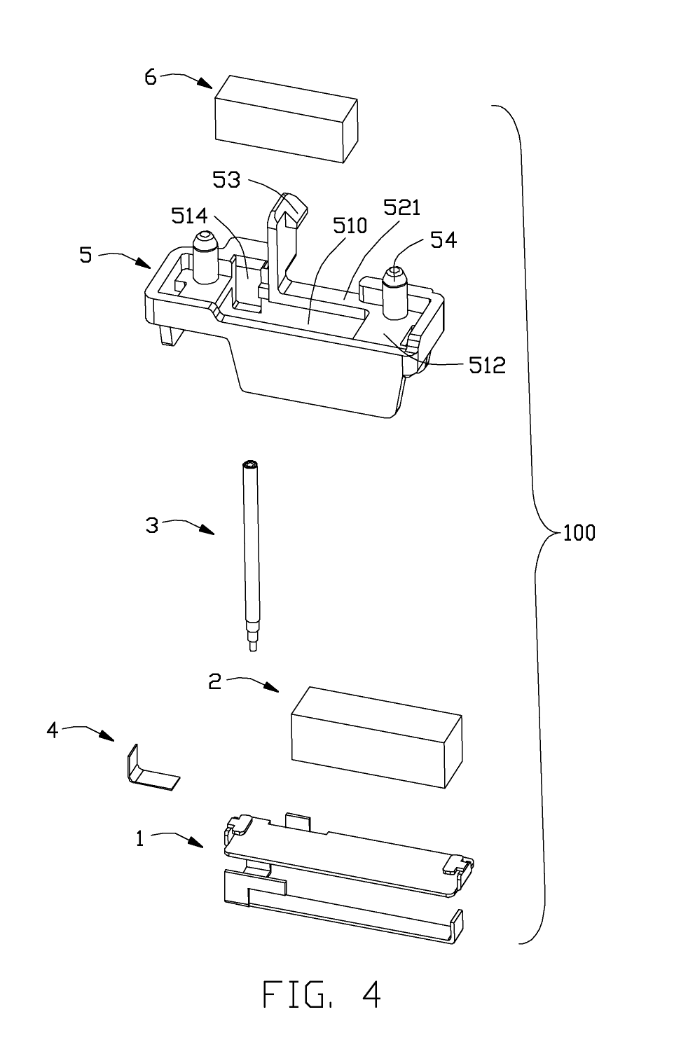

Referring to FIGS. 3 and 4, the insulating holder is made from insulating material and includes a bottom wall 51, a pair of longer sidewalls 52 extending upwards from the longitudinal sides of the bottom wall 51 and a pair of short sidewalls 55 extending from the bottom wall, thereby defining a receiving space to receive the antenna unit 10. The bottom wall defines an upper face 511 to support the antennal unit 10 and a lower face 512 opposite to the upper face. The grounding plate 12 the antenna body 1 is hold on the upper face 511 of the bottom wall, the radio plate 13 and the connecting plate 12 are surrounded between the sidewalls 52, 53. The bottom wall 51 defines a central opening 510 and two retaining holes 513 running through the upper and lower faces. The grounding plate 12 is partially exposed to the central opening 510 and the conductive gasket 6 goes into the central opening 510 to connect with the grounding plate 11. The retaining legs 112 are inserted into the retaining holes 513 and then extend to the lower face 512 of the bottom wall, so that the antenna unit 10 is retained in the holder 5. The holder 5 defies a slot 514 at one longer sidewall 52 to receive the feeder cable 3. A clawer 53 and two aligned posts 54 extend downwards from the lower face 512 to mount the holder in an electronic device (not shown) in which the antennal assemble 100 is mounted, wherein the lower face 512 of the bottom wall is confronting with the electronic device.

Referring to FIGS. 2, 3 and 6 illustrating an assemble method of the antenna assembly 100, the antenna body 1 is formed, the insulating spongy 2 is assembled to the antenna body 1 and then the feeder cable 3 is solder to the antenna body 1 to form the antenna unit. Secondly, the antenna unit 10 is assembled to the insulating holder 5, wherein the grounding plate 11 is hold on the upper surface 511 of the bottom wall 51, the retaining legs 112 are inserted in the retaining holes and bend to retain with the bottom wall 51, the feeder cable 3 is receiving in the slot 514. Then, the conductive gasket 6 is assembled through the central opening 510 and connecting with grounding plate 11 of the antenna body 1. The metal foil 4 is soldered to a point of the grounding plate near to the high frequency radio section 133, to adjust signal noise produced by manufactured error. Lastly, the antenna assembly 100 is mounted to the electronic device, wherein the antenna assembly 100 is pressed and the clawer 53 is engaged with the electronic device.

The antenna body 1 stands up below or flush with a top of the sidewalls 52, 53 to protect the antenna unit. The insulating spongy 2 provides a deformation space when the assembly 100 is pressed to assemble to the electronic device. The clawer 53 is facility to assembly. The device-retaining clawer 53 extends downwards from a first sidewall 521 of said two longer sidewalls 52 and is intersect with the first sidewall.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna assembly adapted for mounting on an electronic device, the antenna assembly comprising:
an antenna body comprising a horizontal grounding plate, a radio plate and a connecting plate connecting with the grounding plate and the radio plate;
a feed cable connecting with the antenna body;
an insulating holder defining a bottom wall and sidewalls extending from the bottom wall, the grounding plate of the antenna body being held on an upper face of the bottom wall, the radio plate and a connecting plate being surrounded between the sidewalls;
wherein the grounding plate defines a retaining leg retained in the insulating holder and extending to a lower face of the bottom wall opposite to the upper face, the lower face of the bottom wall is confronting with the electronic device.

2. The antenna assembly as claimed in claim 1, wherein the insulating holder defines a clawer and a pair of aligned posts extending downward from the lower face of the bottom wall.

3. The antenna assembly as claimed in claim 1, further comprising an conductive gasket, wherein the bottom wall defines a central opening to expose a part of the grounding plate, the conductive gasket is received in the central opening and connecting with the grounding plate.

4. The antenna assembly as claimed in claim 3, wherein one side wall defines a slot at an inner face thereof, the feeder cable goes through the slot.

5. The antenna assembly as claimed in claim 1, further comprising an insulating spongy, wherein the insulating spongy is sandwiched between the radio plate and the grounding plate.

6. The antenna assembly as claimed in claim 5, wherein the antenna body stands up below or flush with a top of the sidewalls.

7. An antenna assembly adapted for mounting in an electronic device, comprising:
an antenna unit comprising an antenna body, a feed cable connecting with the antenna body, an insulating spongy received in the antenna unit and supporting the antenna body at least in a vertical direction; and
an insulating holder defining a receiving space;
wherein the antenna unit is receiving and retained in the receiving space of the insulating holder;
wherein the insulating holder defines a device-retaining clawer from a lower surface of the bottom wall for mounting the antenna assembly within the electronic device.

8. The antenna assembly as claimed in claim 7, wherein the insulating holder comprises a bottom wall and two opposite sidewalls commonly defining said receiving space.

9. The antenna assembly as claimed in claim 8, wherein the device-retaining clawer extend downwards from a first sidewall of said two sidewalls, the device-retaining clawer intersect with the first sidewall.

10. The antenna assembly as claimed in claim 7, wherein the insulating holder defines two aligned posts from a lower surface of the bottom wall.

11. The antenna assembly as claimed in claim 7, wherein the antenna body defines two retaining legs retained in the bottom wall and exposing to a lower surface of the bottom wall.

12. An antenna assembly for assembling to an electronic device, comprising:
an antenna body comprising a horizontal grounding plate, a radiating plate and a connecting plate connecting with the grounding plate and the radiating plate, said radiating plate and said grounding plate being spaced from each other in a first direction;
an insulative holder defining an upward receiving space to receive said antenna body therein, and forming a downward locking claw opposite to said receiving space;
a feed cable connecting with the antenna body and extending out of the insulative holder; wherein
the insulative holder including said locking claw, is configured to be adapted to be assembled into the electronic device in said first direction.

13. The antenna assembly as claimed in claim 12, wherein said grounding plate includes a tab extending in the first direction on which an outer conductor of the feed cable is connected.

14. The antenna assembly as claimed in claim 13, wherein a front region of the feed cable extends in the first direction.

15. The antenna assembly as claimed in claim 12, wherein said grounding plate includes a pair of retaining legs to secure to the insulative holder.

16. The antenna assembly as claimed in claim 12, wherein the antenna body is configured to be received within the receiving space in the first direction.

17. The antenna assembly as claimed in claim 12, wherein said insulative holder forms an opening for inspecting connection between the feed cable and the antenna body.

18. The antenna assembly as claimed in claim 12, further including a metal foil connected to the grounding plate and extending out of the insulative holder.

19. The antenna assembly as claimed in claim 12, wherein said insulative holder further includes an alignment leg for facilitating assembling the antenna assembly into the electronic device.
